(19) United States
(12) Patent Application Publication
(10) Pub. No.: US 2009/0150498 A1
(43) Pub. Date: Jun. 11, 2009

(54) Identifying a Plurality of Related Electronic Messages and Combining the Plurality of Related Messages Into a Composite View

(76) Inventors: Steven Joseph Branda, Rochester, MN (US); William Thomas Newport, Rochester, MN (US); John Joseph Stecher, Rochester, MN (US)

Correspondence Address: WOOD, HERRON & EVANS, L.L.P. (IBM), 2700 CAREW TOWER, 441 VINE STREET, CINCINNATI, OH, 45202, US

(21) Appl. No.: 11/952,234

(22) Filed: Dec. 7, 2007

(51) Int. Cl. G06F 15/16

(52) U.S. Cl. 709/206

(57) ABSTRACT

A program product, an apparatus, and a method that identify a plurality of related electronic messages and combine the plurality of the related electronic messages into a composite view are provided. Also provided is a method that searches a first account of a first user to identify a plurality of related electronic messages stored in the first account and searches a second account of a second user to identify at least one other electronic message that is associated with the plurality. By doing so, a user may be provided with a more complete email chain, often leading to an increase in productivity, improved collaboration, and a reduction of duplicate data.

### FIELD OF THE INVENTION

The invention relates to computers and computer systems, and in particular, to electronic messages in email systems.

### BACKGROUND OF THE INVENTION

The Internet has profoundly changed many aspects of contemporary society, and has become an increasingly important resource for numerous educational, entertainment, and commercial purposes. The Internet facilitates information exchange between users, and electronic messages such emails have emerged as a popular form of communication, both for personal and business use.

An email typically includes a header and a body. The header may include information on the sender of the email, the recipient of the email, the recipient of a carbon copy (i.e., cc) of the email, and/or the recipient of a blind carbon copy (i.e., bcc) of the email. The header may also include the subject of the email and a time stamp indicating when the email was sent. The body typically includes the message content of the email and an email history of the email. The email history includes the message content of emails that came before the email.

An email may be an original message that is composed for the first time, a reply to another email (e.g., a reply to an original electronic message), or a forward of another email (e.g., a forward of an original electronic message). In the latter instances, the email typically has an email history in the body. As such, the message content of the email replied to or forwarded may be displayed as the email history. The header may indicate the type of the email.

An email system is typically utilized to display emails. Email systems typically permit users to exchange emails over a computer network, including via the Internet. In particular, an email system permits a user to send an electronic message to one or more users and to receive electronic messages from one or more users. Each user typically has at least one email account associated with him or her for the emails in an email system. Users may utilize the same type of email system or a different type of email system to exchange emails.

Email systems are typically implemented via a client-server setup. However, the steps taken to accomplish the tasks of receiving, viewing, composing, and sending emails depend upon the functionality accorded to the email client and the email server. In some email systems, for instance, new emails are received by the email server. To retrieve the emails, the user connects to the email server via his or her email client, the emails are downloaded and stored in the email client, and the emails are deleted from the email server. Afterwards, the user may search his or her email client for particular emails. On the other hand, in some email systems, emails are not downloaded to an email client from the email server, instead, the emails typically stay in the email server after they are received and a user may read them directly from the email server via his or her email client. If the user wants to search for a particular email, the email server is searched.

Regardless of the setup, one problem that users may encounter with their emails stems from the way that emails are organized. Typically, emails are organized chronologically in a user's inbox in the email client, with the emails received most recently on top. To find an email, a user generally scrolls through his or her inbox until the user finds the email, or if the email client provides a search function, the user may be able to input a keyword to try to locate the email. However, these conventional techniques are generally not efficient, with the latter approach often returning a multitude of emails to review.

This inefficiency is especially pronounced when a user is trying to handle an urgent customer problem. In particular, solving customer problems is an important area for businesses that often directly impacts customer satisfaction, market opinion, and consequently, product and service sales. Solving customer problems typically requires immediate and constant collaboration and attention from users in several areas such as technical, sales, support, and management on any given matter. But this immediate and constant attention, however, often results in a very active but disconnected email chain. With multiple users responding to emails at approximately the same time, a user may not see what another user stated in his or her email prior to sending an email, and vice versa.

The conventional techniques tend to be of little assistance. For instance, a user may utilize the search function to search for a topic, but the search function typically returns multiple disconnected emails, many of which include duplicate information in the email histories. The disconnected emails, as well as the duplicate data, typically make it difficult for a user to quickly learn the current status of a pending project or to determine what has already occurred since it is unlikely that the user will be able to find a single email with an entire history of the discussion.

As such, the user may have to waste time reading through many of the disconnected emails and try to piece together the status of the problem, for instance, from the thirty or so emails returned by the search function. Users involved from the very beginning, and especially a user brought into the project later on, may thus experience difficulty due to the conventional techniques, often leading to reduced productivity and other inefficiencies.

In an attempt to alleviate some of these inefficiencies, some email clients thread emails in inboxes and display the emails in threaded views. A thread is a group of emails that are organized according to parent-child relationships. By threading, an email client may create groupings of emails organized in parent-child relationships based on which emails are replies to which emails. However, emails, which may nonetheless be pertinent, may not be included in a threaded view if they do not fit into a parent-child relationship.

Moreover, a user may not have all pertinent emails in his or her inbox. For instance, when a user joins a project at a later time, the user typically has not received all the emails prior to joining, and may not have access to them either. As email clients typically only thread emails in an inbox, if an email is not in the inbox, the user may not be able to benefit from threading. Furthermore, any threaded view will likely be incomplete. Threading also may not ameliorate the duplicate data in the email histories that hinder review.

A need therefore exists in improving email systems, in particular, an improved manner of organizing electronic messages, which generally reduces the burden on users and facilitates quick review of electronic messages.

### BRIEF SUMMARY OF THE INVENTION

The invention addresses these and other problems associated with the prior art by providing a program product, an apparatus, and a method that identify a plurality of related electronic messages and combine the plurality of the related electronic messages into a composite view. Also provided is a method that searches a first account of a first user to identify a plurality of related electronic messages stored in the first account and searches a second account of a second user to identify at least one other electronic message that is associated with the plurality. By doing so, a user may be provided with a more complete email chain, often leading to an increase in productivity, improved collaboration, and a reduction of duplicate data.

Consistent with the invention, some embodiments may identify a plurality of related electronic messages, wherein a first electronic message among the plurality of electronic messages is a reply to a second electronic message and includes a copy of message content from the second message embedded therein and combine the plurality of related electronic messages into a composite view, including omitting from the composite view the copy of the message content from the second electronic message embedded in the first electronic message, wherein the composite view includes the first and second electronic messages. Consistent with the invention, some embodiments may search a first account of a first user to identify a plurality of related electronic messages stored in the first account and search a second account of a second user to identify at least one other electronic message that is associated with the plurality of related electronic messages stored in the first account, wherein the other electronic message is not stored in the first account and the first user did not have access to the other electronic message.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF THE SEVERAL VIEWS OF THE DRAWINGS

FIG. 1 is a block diagram of a client-server implementation of an email system consistent with the principles of the present invention.

FIG. 2 is a block diagram of an exemplary routine for combining a plurality of related electronic messages into a composite view consistent with the principles of the present invention.

FIG. 3 is a block diagram of an exemplary routine for combining another electronic message with the composite view consistent with the principles of the present invention.

### DETAILED DESCRIPTION OF THE INVENTION

Embodiments consistent with the invention may identify a plurality of related electronic messages and combine the plurality of the related electronic messages into a composite view. Embodiments consistent with the invention may search a first account of a first user to identify a plurality of related electronic messages stored in the first account and search a second account of a second user to identify at least one other electronic message that is associated with the plurality. An electronic message may be practically any data that may be sent and/or received such as an email, an instant message, an instant message chat, an attachment, etc. The first account may be stored in a client, such as an email client, and the second account may be stored in a server, such as an email server.

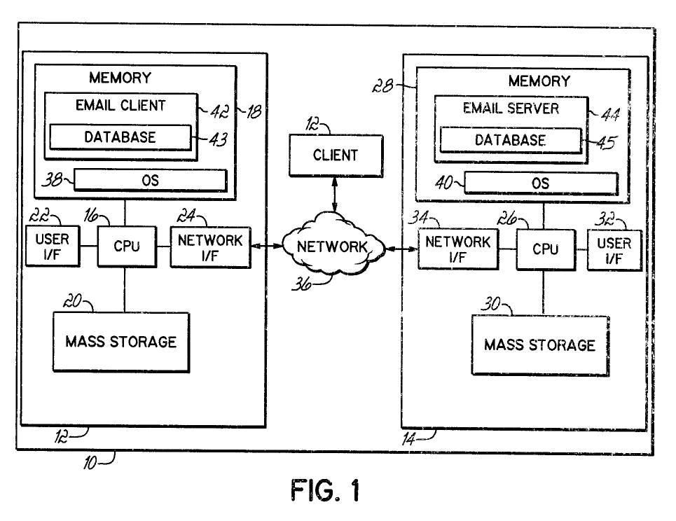

Turning now to the Drawings, wherein like numbers denote like parts throughout the several views, FIG. 1 illustrates an exemplary email system 10 consistent with the principles of the present invention, implemented as a client-server based computer system or environment. System 10 includes at least one apparatus, e.g., one or more client computers 12 (e.g, email client) and one or more server computers 14 (e.g., email server). For the purposes of the invention, each computer 12, 14 may represent practically any type of computer, computer system or other programmable electronic device capable of functioning as a client and/or server in a client-server environment. Moreover, each computer 12, 14 may be implemented using one or more networked computers, e.g., in a cluster or other distributed computing system. Moreover, as is common in many client-server systems, typically multiple client computers 12 will be interfaced with a given server computer 14. Furthermore, in some embodiments, system 10 may be implemented as a peer-to-peer system or environment, where computer 12 may function as a client and/or server and computer 14 may function as a client and/or server.

Computer 12 typically includes a central processing unit 16 including at least one microprocessor coupled to a memory 18, which may represent the random access memory (RAM) devices comprising the main storage of computer 12, as well as any supplemental levels of memory, e.g., cache memories, non-volatile or backup memories (e.g., programmable or flash memories), read-only memories, etc. In addition, memory 18 may be considered to include memory storage physically located elsewhere in computer 12, e.g., any cache memory in a processor in CPU 16, as well as any storage capacity used as a virtual memory, e.g., as stored on a mass storage device 20 or on another computer coupled to computer 12. In particular, resident in memory 18 is a computer program such as an email client 42, and stored in email client 42 is a database 43. Database 43 stores electronic messages. An account for a user (not shown) may be associated with email client 42 and database 43. Computer 12 also typically receives a number of inputs and outputs for communicating information externally. For interface with a user or operator, computer 12 typically includes a user interface 22 incorporating one or more user input devices (e.g., a keyboard, a mouse, a trackball, a joystick, a touchpad, and/or a microphone, among others) and a display (e.g., a CRT monitor, an LCD display panel, and/or a speaker, among others). Otherwise, user input may be received via another computer or terminal.

For additional storage, computer 12 may also include one or more mass storage devices 20, e.g., a floppy or other removable disk drive, a hard disk drive, a direct access storage device (DASD), an optical drive (e.g., a CD drive, a DVD drive, etc.), and/or a tape drive, among others. Furthermore, computer 12 may include an interface 24 with one or more networks (e.g., a LAN, a WAN, a wireless network, and/or the Internet, among others) to permit the communication of information with other computers and electronic devices. It should be appreciated that computer 12 typically includes suitable analog and/or digital interfaces between CPU 16 and each of components 18, 20, 22 and 24 as is well known in the art.

In a similar manner to computer 12, computer 14 includes a CPU 26, memory 28, a computer program such as an email server 44, a database 45 stored in email server 44, mass storage 30, user interface 32 and network interface 34. Database 45 stores electronic messages. An account for a user (not shown) may be associated with email server 44 and database 45. However, given the nature of computers 12 and 14 as client and server, in many instances computer 14 will be implemented using a multi-user computer such as a server computer, a midrange computer, a mainframe, etc., while computer 12 will be implemented using a desktop or other single-user computer. As a result, the specifications of the CPU's, memories, mass storage, user interfaces and network interfaces will typically vary between computers 12 and 14. Other hardware environments are contemplated within the context of the invention. Computers 12, 14 are generally interfaced with one another via a network 36, which may be public and/or private, wired and/or wireless, local and/or wide-area, etc. Moreover, network 36 may represent multiple, interconnected networks. In the illustrated embodiment, for example, network 36 may include the Internet.

Each computer 12, 14 operates under the control of an operating system 38, 40, and executes or otherwise relies upon various computer software applications, components, programs, objects, modules, data structures, etc. (e.g. email client 42 and email server 44). Moreover, various applications, components, programs, objects, modules, etc. may also execute on one or more processors in another computer coupled to computer 12, 14 via a network, e.g., in a distributed or client-server computing environment, whereby the processing required to implement the functions of a computer program may be allocated to multiple computers over a network.

In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable media used to actually carry out the distribution. Examples of computer readable media include, but are not limited to, physical, recordable type media such as volatile and non-volatile memory devices, floppy and other removable disks, hard disk drives, magnetic tape, optical disks (e.g., CD-ROMs, DVDs, etc.), among others, and transmission type media such as digital and analog communication links.

In addition, various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization (e.g., components may be added and/or omitted) and allocation of program functionality described herein.

In the context of the invention, a plurality of related electronic messages may be identified and combined into a composite view by email client 42 of computer 12. To identify the plurality of related electronic messages, database 43, stored in email client 42, may be accessed and searched. The composite view may be stored in database 43 and may be displayed by email client 42.

Once identified, email client 42 may be utilized to parse the electronic messages, to sort them, and to omit from the composite view duplicate copies of the message content of embedded electronic messages. Email client 42 may also be utilized to send the composite view, for example, as an email, to an email client, an email server, or both. By doing so, a user can provide another user with a single email containing a more complete email chain that can help him or her quickly access the status of a problem. To send the composite view, the composite view may first be transmitted from email client 42 to email server 44, and email server 44 will transfer the composite view to an email client, to an email server, or both.

In the context of the invention, another electronic message may be identified from database 45, which is stored in email server 44 of computer 14. Those of ordinary skill in the art may appreciate that by doing this, a user can be provided with an electronic message that he or she did not have access to and receive a more complete email chain. Email server 44 may also be utilized to request permission from a sender and/or recipient of the other electronic message. Permission may be requested before displaying the text of the identified other electronic message in the composite view to maintain privacy and confidentiality.

Email server 44 may also provide email client 42 with a place holder for the other electronic message and information on how to integrate the place holder into the composite view. Once permission is granted, email server 44 may notify email client 42 of the permission and the placeholder to replace. Email client 42 may use the information to replace the place holder in the composite view with the message content of the other electronic message. Alternatively, the email server 44 may send the other electronic message in an encrypted form to email client 42 to integrate it into the composite view. Once permission is received, email server 44 may send the decryption key to email client 42 to decrypt the other electronic message.

In some embodiments, for instance, such as in embodiments where electronic messages are stored in database 45 of email server 44, the composite view may also be stored in email server 44 and displayed via in email client 42. As such, email server 44 may directly modify the composite view with a place holder or an encrypted version of an electronic message, and upon receiving permission, email server 44 may directly modify the composite view to display the electronic message. Moreover, database 45 may be accessed and search (e.g., email histories) to identify a plurality of related electronic messages. Nonetheless, once identified, the electronic message may be combined with the composite view and sent to an email client, an email server, or both.

Those skilled in the art will recognize that the exemplary system illustrated in FIG. 1 is not intended to limit the present invention. Indeed, those skilled in the art will recognize that other alternative hardware and/or software environments may be used without departing from the scope of the invention. For instance, in some embodiments, an instant messaging client, an instant messaging server, an instant messaging system, etc. may be utilized.

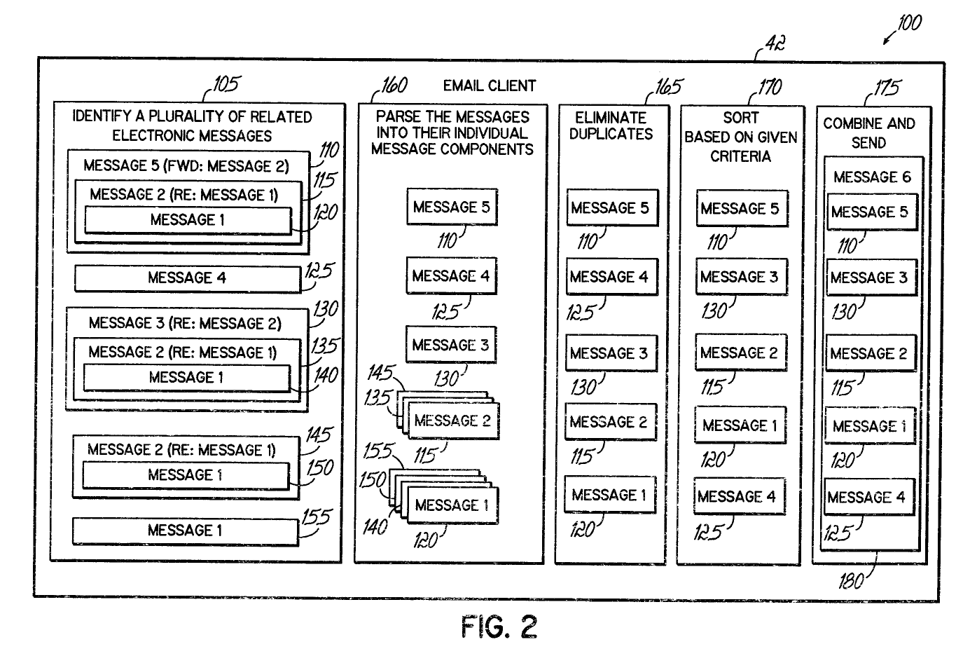

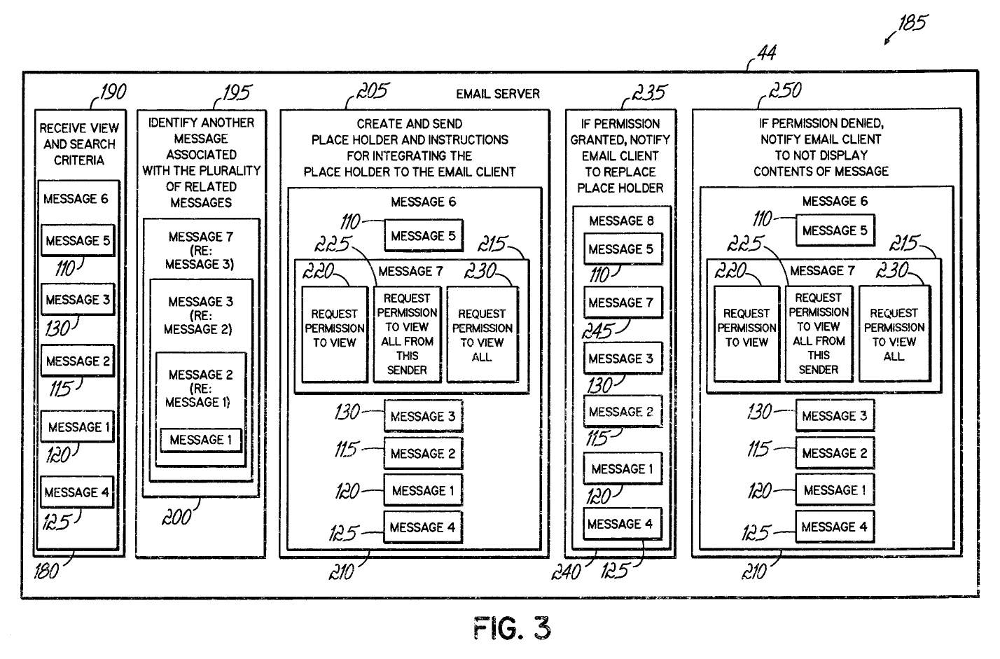

Turning to FIG. 2, FIG. 2 is a block diagram of an exemplary routine 100 for combining a plurality of related electronic messages into a composite view. To facilitate the discussion of routine 100, a running example is provided in FIG. 2 (and FIG. 3). In particular, the exemplary instructions of routine 100 are illustrated in the top portion of the block diagram while the running example, which generally reflects the effect of each instruction, is illustrated in the remaining portion of the block diagram. Routine 100 may be executed by email client 42.

Turning now to block 105 of routine 100, the instruction to identify a plurality of related electronic messages is illustrated in the top portion of block 105 and the running example is illustrated by blocks 110-155. As an overview, block 110, block 125, block 130, block 145, and block 155 illustrate five electronic messages that may be identified. Message 5 of block 110 is an electronic message that forwards message 2 of block 115. A copy of the message content of message 2 is embedded in message 5. Message 2 is a reply to message 1 of block 120. A copy of the message content of message 1 is embedded in message 2. Message 2 and message 1 are both electronic messages. For instance, message 2 may be an email and message 1 may be an instant message chat sent as an email. Message 2 and message 1 make up the email history of message 5. However, in some embodiments, message 5 may also be considered to be part of the email history.

Next, message 4 of block 125 is an original electronic message and does not have an email history associated with it. Message 3 of block 130 is an electronic message that is a reply to message 2 of block 135, and message 2 is a reply to message 1 of block 140. As described above, a copy of the message content of message 2 is embedded in message 3. Furthermore, a copy of the message content of message 1 is embedded in message 2. Message 2 of block 135 and message 1 of block 140 constitute the email history of message 3.

Message 2 of block 145 is a reply to message 1 of block 150. A copy of the message content of message 1 is embedded in message 2. Message 1 of block 155 is an original electronic message and does not have an email history associated with it.

The plurality of related messages may be identified by accessing and searching a database of electronic messages such as database 43. The database may be searched utilizing an email history of an electronic message in the database. For example, the email history of message 3 includes message 2 of block 135 and message 1 of block 140, and by searching the email history of message 3, all three electronic messages (or a subset thereof) may be identified as being related. Message 2 of block 145 and message 1 of block 55 may also be identified as being related based on an email history search.

Database 43 may also be searched utilizing input from a user. For instance, a user may input a keyword, a string (e.g., the name of a project), etc. into a search function of email client 42. This search function may identify electronic messages meeting the search criteria such as message 5 of block 125, message 4 of block 125, message 3 of block 130, message 2 of block 145, and message 1 of block 155, as well as their accompanying email histories, if any. Those of ordinary skill in the art may appreciate that although message 4 of block 125 is an original message without an email history, it may nonetheless be identified as being related to message 5 of block 110, message 3 of block 130, message 2 of block 145, and message 1 of block 135 based upon the user's input. Thus, electronic messages from different threads, having different email histories or no email histories, etc. may be identified as related electronic messages.

Input by the user may also include a manual selection of electronic messages. The user may manually select, for instance, message 5 of block 110 and message 4 of block 125 to be identified as related electronic messages.

Those of ordinary skill in the art may also appreciate that under conventional threading techniques, message 5 of block 110 and message 4 of block 125 would generally not be threaded. For instance, message 5 is a forwarded message and message 4 of block 125 may have a different subject or may be a reply to a blind carbon copy (e.g., bcc), etc. Nonetheless, under the principles of the present invention, message 5 of block 110 and message 4 of block 125 may be identified as related electronic messages even though under conventional threading technology, those electronic messages are generally not threadable and neglected.

Additionally, those of ordinary skill in the art may appreciate that in some embodiments, message 3 of block 130, message 2 of block 145, and message 1 of block 155 may be grouped together via conventional threading technology. As such, these three electronic messages may be identified as a single electronic message instead of three separate electronic messages. Moreover, those of ordinary skill in the art will appreciate that other techniques for identifying a plurality of related electronic messages are contemplated within the scope of the invention. Irrespective of the mechanism utilized, a plurality of related electronic messages may be identified.

Turning now to block 160, electronic messages may be parsed into their individual message components in block 160. In particular, many of the electronic messages identified in block 105 may contain long email histories with multiple embedded electronic messages. Thus, email client 42 may parse all the electronic messages, for example, from the email histories into their individual message components. Email client 42 may utilize headers, spacing, signatures, font changes, etc. to separate one electronic message from another. As such, an instant message chat embedded in an email history, for instance, may be separated from an email. In some embodiments, a user may also be able to manually parse out electronic messages into their individual message components.

To continue with the running example, after parsing, message 5 is illustrated once in block 160 because message 5 was identified only once in the plurality of related electronic messages of block 105. Message 4 and message 3 also appear only once in block 160 because they were each identified once in the plurality of related electronic messages of block 105. Message 2, on the other hand, was identified three times in the plurality of related electronic messages, appearing in two email histories as block 115 and block 135, and as block 145. Thus, message 2 is parsed out and illustrated three times in block 160. Message 1 is illustrated four times in block 160 because it was identified four times in the plurality of related electronic messages as block 120, block 140, block 150, and block 155.

Next, block 165 eliminates duplicates. Header comparisons as well as text comparison algorithms, such as those that are conventionally available, may be utilized to eliminate duplicate electronic messages. As such, a copy of each unique electronic message identified in the plurality of related electronic messages may be kept to combine into the composite view.

In particular, as message 5, message 4, and message 3 were only identified and parsed out once from the plurality of related electronic messages, the blocks representing each of these are illustrated in block 165. With respect to message 2, message 2 of blocks 135 and 134 were eliminated as duplicates and message 2 of block 115 was kept in block 165. With respect to message 1, message 1 of blocks 140, 150, and 155 were eliminated as duplicates and message 1 of block 120 was kept in block 165. Although the most recent copies of message 2 and message 1 were selected, in some embodiments, the oldest ones could have been selected, etc.

Next, block 170 sorts the messages based on a given criteria. For instance, the messages may be sorted chronologically or in a reverse chronological order using the date and/or time that the messages were sent. Other factors that can affect the order or the grouping may be utilized. Continuing with the running example, the messages illustrated in block 170 from block 165 were first sorted by date and then by relationship. In particular, as message 4 was not a parent or a child of any of the other messages, and was sent the earliest, message 4 of block 125 is illustrated at the bottom of the list. As message 5 of block 110 and message 3 of block 130 each include message 2 in their email history, message 5 and message 3 necessarily were sent after message 2 and therefore are illustrated above message 2. Message 5 was sent the most recently, and therefore is illustrated at the top of the list in block 170. Message 3 follows message 5, and message 2, which is a reply to message 1, appears before message 1.

In some embodiments, a user may choose to group the messages into a threaded parent-child order. Furthermore, a link may be provided next to each message to take the user back to the parent message (i.e., the message that was replied to). Those of ordinary skill in the art will appreciate that other factors may also be utilized to sort the messages.

Next, block 175 combines the electronic messages into a composite view and sends the composite view to an email client or to an email server. In particular, if a user wants to send the composite view to another user, email client 42 can transfer the composite view to email server 44, which may then transfer the composite view as an email to the other user's email client (or an email server associated with that email client). As such, the other user may receive all the relevant electronic messages in a comprehensive email, review the composite view, and get a better understanding of the status of, for example, a project.

Block 180 illustrates a composite view of the sorted electronic messages of block 170. The composite view of block 180 may be converted into an electronic message, such as message 6, and can be sent to another user. In some embodiments, message 6 of block 180 may be fully compatible with the mechanism that was used to create it. For instance, if the recipient of message 6 decides to combine additional electronic messages that he or she has received on that topic, for example, a week later, routine 100 may be utilized to combine the additional messages into the composite view. In particular, the messages initially received from message 6 may simply be parsed into their individual message components again and so forth. In some embodiments, routine 100, or at least a portion of routine 100, may be executed as often as needed to provide a real time composite view. The combination of additional electronic messages into a composite view may occur automatically or may be initiated by a user.

Turning now to FIG. 3, FIG. 3 is a block diagram of an exemplary routine 185 for combining another electronic message with the composite view. As with routine 100 of FIG. 2, the instructions of routine 185 are illustrated in the top portion of the block diagram, and the running example, which generally reflects the effect of each instruction, is illustrated in the remaining portion of the block diagram. Routine 185 may be executed by email server 44.

Turning to routine 185, email server 44 may receive the composite view of block 180 as message 6 from email client 42 in block 190. The search criteria utilized to identify the plurality of related electronic messages in block 105 of FIG. 2 is also received in email server 44 from email client 42. The criteria may be utilized to mine database 45 of email server 44 and identify another electronic message that is not in database 43 of email client 42, but that is nonetheless associated with the plurality of related electronic messages identified from database 43 of email client 42. As such, electronic messages not available in the user's email client may be identified and provided to the user.

Next, another message associated with the plurality of related messages may be identified in block 195. In particular, the received search criteria, as well as headers, dates, and/or the context of the body of the messages from the composite view of block 180 may be utilized to identify the other electronic message. Those of ordinary skill in the art will appreciate that other techniques for identifying electronic messages in a database may be utilized as well. Block 200 illustrates a message 7 that may be identified in database 45 in email server 44, but that is not available to email client 42. Message 7 of block 200 is a reply to message 3. Message 3, along with message 2 and message 1, are embedded in message 7.

A place holder for the identified message may be created and sent to email client 42 in block 205 by email server 44. Instructions for integrating the place holder into the composite view may also be created and sent to email client 42 in block 205. In some embodiments, email server 44 may directly place the place holder in the composite view. Nonetheless, the place holder may have three different buttons requesting various levels of permission for viewing the identified other electronic message. Upon viewing the place holder in the email client, the user may click on one of the buttons of the place holder which may then cause email server 44 to request the desired level of permission from a sender of the identified other electronic message, or in some embodiments, from a recipient of the identified other electronic message.

Those of ordinary skill in the art may appreciate that it may be preferable to obtain permission from a sender and/or a recipient of the message before that message is displayed to a user that did not previously receive the message. In particular, those of ordinary skill in the art may appreciate that although email server 44 may request permission directly from the original sender and/or sender of an electronic message, an electronic message can simply be forwarded to another, and thus, for messages that are not tagged as private or otherwise cannot be forwarded, permission can be requested from an original recipient and/or other recipient. Moreover, in some embodiments, email server 44 may also send the permission request to a recipient list or to a subset of a recipient list such as the two or three users on the recipient list that have recently been the most active. As such, this mechanism may reduce the chances that a permission request is not read because the original sender was, for instance, out of the office or otherwise unavailable. The available permission modes may be controlled by email server 44. Other permission modes may also be available consistent with the principles of the invention.

Block 215 illustrates a place holder for message 7 that may be created and sent to email client 42 by email server 44. Block 210 illustrates the integration of place holder 215 into composite view of block 180 by email client 42. The same sort utilized in block 170 of FIG. 2 may be utilized to integrate place holder 215. If a user selects block 220 via email client 42, email server 44 may send a request to a sender or a recipient of message 7 to obtain permission for the user to review message 7. If the user selects block 225, email server 44 may send a request to allow a user to view all place holders from the sender of message 7. Thus, if there was a message 9 from the same sender of message 7, for instance, message 9 would also be made available to the user if the sender approves the request for permission of block 225. If the user selects block 230, email server 44 may send requests to the original sender and/or to a recipient of each electronic message represented by the place holders in the composite view.

If a user clicks on one of the permission buttons in the place holder, and permission is granted, email server 44 may notify email client 42 to replace the place holder with the corresponding electronic message in block 235. As part of the notification, email server 44 may send a message to the email client with the text of the electronic message and an indication as to the place holder that should be replaced with the text. Email client 42 may then replace the place holder in the composite view with the text.

As illustrated by block 240, place holder 215 was replaced with message 7 of block 245, without its email history. Block 240 also illustrates the new composite view that may be converted into an email, such as message 8, and may be sent to an email client or email server. Furthermore, as discussed above in connection with block 175 of FIG. 2, the new composite view of block 240 may also be recombined by routine 100 to incorporate additional electronic messages received by a user.

On the other hand, if permission was denied, email server 44 may notify email client 42 of the denied permission. In this instance, email client 42 will not display the contents of the identified other electronic message. As illustrated by block 210, the composite view may be displayed to the user with place holder 215 for message 7 until permission is granted.

In some embodiments, encryption may be utilized instead of place holders. For instance, the identified other electronic message may be integrated into the composite view in an encrypted format. Once permission to view the message is received, email server 44 may send email client 42 the decryption key. Email client 42 can then decrypt the message and make it available for viewing.

Although exemplary routines have been discussed hereinabove, those of ordinary skill in the art will appreciate that embodiments where electronic messages are stored in an email client as well as embodiments where electronic messages are stored in an email server are contemplated. For instance, consistent with the principles of the present invention, the composite view may be stored in database 45 of email server 44 instead of database 43 of email client 42, and email server 44 may directly integrate a place holder into the composite view and replace it with the electronic message once permission is received. Similarly, email server 44 may directly encrypt a message in the composite view and decrypt the encrypted message once permission is granted.

Nonetheless, those of ordinary skill in the art may appreciate that based on the principles of the present invention, a user may be provided with a composite view that may help him or her get up to speed faster on a topic. Furthermore, additional electronic messages may be identified from an email server and combined into the composite view. As such, messages that the user may not be aware of may be identified to provide the user with a more complete picture of the situation. As a result, collaboration in an organization may be improved and critical problems may be resolved faster. Additionally, redundant data may be eliminated, costs may be reduced, and time may be saved.

Various modifications may be made to illustrated embodiments without departing from the spirit and scope of the invention. Therefore, the invention lies in the claims hereinafter appended.

What is claimed is:

1. A method of organizing electronic messages, the method comprising:
identifying a plurality of related electronic messages, wherein a first electronic message among the plurality of electronic messages is a reply to a second electronic message and includes a copy of message content from the second electronic message embedded therein; and
combining the plurality of related electronic messages into a composite view, including omitting from the composite view the copy of the message content from the second electronic message embedded in the first electronic message, wherein the composite view includes the first and second electronic messages.

2. The method of claim 1, wherein identifying the plurality of related electronic messages further comprises:
accessing a database of electronic messages; and
searching the database of electronic messages based on a history of at least one message in the database of electronic messages.

3. The method of claim 1, wherein identifying the plurality of related electronic messages further comprises:
accessing a database of electronic message; and
searching the database of electronic messages based on input by a user in an email client.

4. The method of claim 1, wherein omitting from the composite view further comprises parsing the second electronic message from the first electronic message.

5. The method of claim 1, further comprising sorting the plurality of related electronic messages prior to combining the plurality of related electronic messages into the composite view.

6. The method of claim 1, further comprising sending the composite view to at least one of an email client or an email server.

7. The method of claim 1, wherein identifying a plurality of related electronic messages comprises accessing a database of electronic messages stored in an email client, further comprising:
identifying in a database of electronic messages stored in an email server at least one other electronic message that is associated with the plurality of related electronic messages to be added to the composite view, wherein the identified other electronic message from the email server is not stored in the database in the email client.

8. The method of claim 7, further comprising combining the identified other electronic message from the email server with the composite view.

9. The method of claim 8, further comprising sending the composite view with the identified other electronic message to at least one of an email client or an email server.

10. The method of claim 8, further comprising requesting permission from at least one of a sender of the other electronic message or a recipient of the other electronic message to display the identified other electronic message in the composite view.

11. The method of claim 10, further comprising:
utilizing a place holder for the identified other electronic message in the composite view; and
replacing the place holder in the composite view with the identified other electronic message after permission to display the identified other electronic message has been obtained.

12. The method of claim 10, further comprising:
encrypting the identified other electronic message in the composite view; and
decrypting the identified other electronic message in the composite view after permission to display the identified other electronic message has been obtained.

13. An apparatus comprising:
a processor,
a memory; and
program code resident in the memory and configured to be executed by the processor to organize electronic messages by identifying a plurality of related electronic messages, wherein a first electronic message among the plurality of electronic messages is a reply to a second electronic message and includes a copy of message content from the second electronic message embedded therein, and combining the plurality of related electronic messages into a composite view, including omitting from the composite view the copy of the message content from the second electronic message embedded in the first electronic message, wherein the composite view includes the first and second electronic messages.

14. The apparatus of claim 13, wherein the program code is further configured to identify the plurality of related electronic messages by accessing a database of electronic messages and searching the database of electronic messages based on a history of at least one message in the database of electronic messages.

15. The apparatus of claim 13, wherein the program code is further configured to identify the plurality of related electronic messages by accessing a database of electronic messages and searching the database of electronic messages based on input by a user in an email client.

16. The apparatus of claim 13, wherein the program code is configured to omit from the composite view by parsing the second electronic message from the first electronic message.

17. The apparatus of claim 13, wherein the program code is configured to send the composite view to at least one of an email client or an email server.

18. The apparatus of claim 13, wherein the program code is configured to identify a plurality of related electronic messages by accessing a database of electronic messages stored in an email client, the program code further configured to identify in a database of electronic messages stored in an email server at least one other electronic message that is associated with the plurality of related electronic messages to be added to the composite view, wherein the identified other electronic message from the email server is not stored in the database in the email client.

19. The apparatus of claim 18, wherein the program code is configured to combine the identified other electronic message from the email server with the composite view.

20. The apparatus of claim 19, wherein the program code is configured to send the composite view with the identified other electronic message to at least one of an email client or an email server.

21. The apparatus of claim 19, wherein the program code is configured to request permission from at least one of a sender of the other electronic message or a recipient of the other electronic message to display the identified other electronic message in the composite view.

22. The apparatus of claim 21, wherein the program code is configured to utilize a place holder for the identified other electronic message in the composite view and replace the place holder in the composite view with the identified other electronic message after permission to display the identified other electronic message has been obtained.

23. The apparatus of claim 21, wherein the program code is configured to encrypt the identified other electronic message in the composite view and decrypt the identified other electronic message in the composite view after permission to display the identified other electronic message has been obtained.

24. A program product, comprising:
program code configured to organize electronic messages by identifying a plurality of related electronic messages, wherein a first electronic message among the plurality of electronic messages is a reply to a second electronic message and includes a copy of message content from the second electronic message embedded therein, and combining the plurality of related electronic messages into a composite view, including omitting from the composite view the copy of the message content from the second electronic message embedded in the first electronic message, wherein the composite view includes the first and second electronic messages; and
a computer readable medium bearing the program code.

25. A method of searching for an electronic message, the method comprising:
searching a first account of a first user to identify a plurality of related electronic messages stored in the first account; and
searching a second account of a second user to identify at least one other electronic message that is associated with the plurality of related electronic messages stored in the first account, wherein the other electronic message is not stored in the first account and the first user did not have access to the other electronic message.
